(19) United States
(12) Patent Application Publication
(10) Pub. No.: US 2026/0318426 A1
(43) Pub. Date: Oct. 15, 2026

(54) CENTRAL OIL CONTROL VALVE

(71) Applicant: BorgWarner Automotive Components (Ningbo) Co., Ltd., Ningbo (CN)

(72) Inventor: Hongwei Yan, Shanghai (CN)

(21) Appl. No.: 19/636,735

(22) Filed: Apr. 1, 2026

(30) Foreign Application Priority Data
Apr. 11, 2025 (CN) 202510453168.6

(51) Int. Cl. F16K 11/07; F01L 1/344

(52) U.S. Cl. CPC F16K 11/0712; F01L 1/3442; F01L 2001/34426

(57) ABSTRACT

A central oil control valve includes a valve body, a valve spool and a valve sleeve. A first working oil port and a second working oil port, which respectively communicate with a phaser advance chamber and a phase retard chamber, are formed in the valve body. A first circular groove is formed in an outer wall of an end, close to the oil inlet chamber, of the valve sleeve. An oil passage, communicating with the first circular groove, is formed in an outer wall of the valve sleeve, and an oil through-hole is formed in the bottom of the oil passage. A main oil inlet is formed in the bottom of the first circular groove. A first ring valve capable of expanding to be opened unidirectionally is assembled in the first circular groove. A return check valve is arranged on the valve spool or the valve sleeve.

### CROSS REFERENCE TO RELATED APPLICATIONS

This application claims the priority to Chinese Patent Application No. 202510453168.6 filed on Apr. 11, 2025, and the entire content of this priority application is incorporated herein by reference in its entirety.

### TECHNICAL FIELD

The present disclosure relates to the technical field of oil control valves, which may be to a central oil control valve.

### BACKGROUND

A central oil control valve, as the core control component of a variable valve timing (VVT) system of an engine, has a complex structure and requires high manufacturing precision. A control valve body, a slide valve sleeve, a control valve spool and a hydraulic check valve are core parts of the central control valve and play an important role in tightening bolts and distributing oil to achieve the control function of the system. The manufacturing precision of the control valve body, the slide valve sleeve and the control valve spool has a direct influence on the performance of the control valve.

At present, most major complex functions in the design of control valves on the market are integrated on a slide valve and a spool sleeve. Typically, a ball-type check valve, generally formed by a spring, a valve seat and a valve plate (steel balls), is adopted, and each of the parts needs to have a precise fit tolerance to function properly, which leads to a complex structure of the valve spool and a high cost. Alternatively, a reed-type check valve may be adopted. For example, Chinese Patent Publication No. CN117703560A discloses a central oil control valve, which includes two check valves, where each of the two check valves is formed by leaf springs and a support in the middle. Although the structure in this patent has fewer parts as compared with traditional structures, it needs two check valves formed by leaf springs, increasing the manufacturing difficulty of the leaf springs; the support needs to be matched with the leaf springs, still leading to a relatively high manufacturing cost.

### SUMMARY

The technical issue to be settled by the present disclosure is to overcome at least one defect in the prior art by providing a central oil control valve, which is simple in structure, flexible in control and low in overall manufacturing cost.

To settle the above technical issue, the present disclosure provides a central oil control valve, including a valve body, a valve spool and a valve sleeve; the valve body is disposed around the valve sleeve, the valve spool is movably assembled in a valve chamber in one end of the valve sleeve in an axial direction, and an oil inlet chamber is formed in the other end of the valve sleeve; a first working oil port and a second working oil port, respectively communicating with a phaser advance chamber and a phaser retard chamber, are formed in the valve body, and a first oil hole and a second oil hole, respectively communicating with the first working oil port and the second working oil port, are formed in the valve sleeve; a first circular groove is formed in an outer wall of the end, close to the oil inlet chamber, of the valve sleeve; an oil passage, extending through the first circular groove in the axial direction, is formed in an outer wall of the valve sleeve; an oil through-hole, communicating with the first oil hole or the second oil hole, is formed in a bottom of the oil passage; a main oil inlet, communicating with the oil inlet chamber, is formed in a bottom of the first circular groove; a first ring valve capable of expanding to be opened unidirectionally under the unction of a radial force is assembled in the first circular groove; a return check valve is arranged on the valve spool or the valve sleeve.

When the valve spool is located at a first position, the main oil inlet unidirectionally communicates with the first oil hole via the oil through-hole, and the second oil hole unidirectionally communicates with the oil passage via a second check valve; or, the main oil inlet unidirectionally communicates with the second oil hole via the oil through-hole, and the first oil hole unidirectionally communicates with the oil passage via the second check valve.

When the valve spool is located at a second position, the main oil inlet unidirectionally communicates with the second oil hole via the oil through-hole, and the first oil hole unidirectionally communicates with the oil passage via the second check valve; or, the main inlet unidirectionally communicates with the first oil hole via the oil through-hole, and the second oil hole unidirectionally communicates with the oil passage via the second check valve.

As an improvement, a receiving cavity with an open end is formed in the valve body, one end of the valve sleeve abuts against a bottom wall of the receiving cavity, and a plug, abutting against the other end of the valve sleeve in the axial direction, is arranged at the open end of the receiving cavity; an anti-rotation protrusion sticks out from an end, close to the valve sleeve, of the plug, and an anti-rotation groove is formed in the corresponding end of the valve sleeve.

As a further improvement, a central through-hole, communicating with the oil inlet chamber, is formed in a bottom of the receiving cavity, and a filter screen, used for covering the central through-hole, is clamped between the corresponding end of the valve sleeve and a bottom wall of the receiving cavity.

As one structure, a second circular groove is formed in the outer wall of the valve sleeve, the second circular groove communicates with the first circular groove via the oil passage, a third oil hole is formed in a bottom of the second circular groove, and a second ring valve capable of expanding to be opened unidirectionally under the action of a radial force is assembled in the second circular groove to form the return check valve; a third circular groove, a fourth circular groove and a fifth circular groove, which are distributed at intervals in the axial direction, are formed in an outer wall of the valve spool.

When the valve spool is located at the first position, the oil through-hole communicates with the first oil hole via the fourth circular groove, and the second oil hole communicates with the oil passage sequentially via the third circular groove and the second ring valve.

When the valve spool is located at the second position, the oil through-hole communicates with the second oil hole via the fourth circular groove, and the first oil hole communicates with the oil passage via the fifth circular groove.

Further, a sixth circular groove is formed in an outer wall of the end, away from the oil inlet chamber, of the valve sleeve, and the sixth circular groove communicates with the first circular groove and the second circular groove via the oil passage; a fourth oil hole is formed in a bottom of the sixth circular groove, and a third ring valve capable of expanding to be opened unidirectionally under the action of a radial force is assembled in the sixth circular groove.

Furthermore, an oil discharge chamber, extending in the axial direction, is formed in the valve spool, and an oil discharge passage, communicating with the oil discharge chamber, is formed in a side wall of an end, away from the oil inlet chamber, of the valve spool; a first oil discharge hole and a second oil discharge hole, communicating with the oil discharge chamber, are formed in a bottom of the third circular groove and a bottom of the fifth circular groove respectively.

Furthermore, a mounting cavity, extending in the axial direction, is formed in the valve spool, a core tube is assembled in the mounting cavity, a gap is formed between an outer circumferential wall of the core tube and an inner circumferential wall of the mounting cavity to form a return oil passage, and a fifth oil hole and a sixth oil hole, which communicate with the return oil passage, are formed in a bottom of the third circular groove and a bottom of the fifth circular groove respectively.

Furthermore, a third oil discharge hole and a fourth oil discharge hole are formed in a side wall of the end, away from the oil inlet chamber, of the valve sleeve; an oil discharge groove, vertically extending through the third oil discharge hole and the fourth oil discharge hole, is formed in the outer wall of the valve sleeve, and an oil discharge passage, communicating with the oil discharge groove, is formed in the plug.

As another structure, a third circular groove, a fourth circular groove and a fifth circular groove, which are distributed at intervals in the axial direction, are formed in the outer wall of the valve sleeve, a support is assembled in a cavity of the valve spool, a return oil passage is formed between the support and an inner wall of the valve spool, and a seventh oil hole, an eighth oil hole and a ninth oil hole, which communicate with the return oil passage, are formed in a bottom of the third circular groove, a bottom of the fourth circular groove and a bottom of the fifth circular groove respectively; an elastic membrane, for fitting and sealing the eighth oil hole, is connected to the support to form the return check valve.

When the valve spool is located at the first position, the oil through-hole communicates with the second oil hole via the third circular groove, and the first oil hole communicates with the oil passage sequentially via the fourth circular groove, the elastic membrane and the return oil passage.

When the valve spool is located at the second position, the oil through-hole communicates with the first oil hole sequentially via the third circular groove, the return oil passage and the fifth circular groove, and the second oil hole communicates with the oil passage via the fourth circular groove and the elastic membrane.

Further, a fifth oil discharge hole is formed in a side wall of the valve sleeve; an oil discharge groove, vertically extending through the fifth oil discharge hole, is formed in the outer wall of the valve sleeve; an oil discharge passage, communicating with the oil discharge groove, is formed in the plug.

Compared with the prior art, the central oil control valve provided by the present disclosure has the following advantages:

According to the oil control valve provided by the present disclosure, check valves integrated in the valve spool are simplified, part of complex functions originally integrated on the valve spool are transferred onto the valve sleeve, and the ring valves capable of expanding to be opened or the reed-type check valve and the support and combinations thereof are integrated on the valve sleeve to realize different oil path control and oil return regulation functions, such that the requirement for internal circulation of oil is satisfied, and flexible control is achieved; in addition, the number of parts of a control valve assembly is reduced, the machining difficulty of the valve spool is lowered, and the cost is greatly reduced.

In addition, the ring valves capable of expanding to be opened are adopted, and the frictional resistance produced when the ring valves are opened and closed is small, such that the reliability is higher, the durability is effectively improved, and a large number of ring valves may be used, thereby simplifying the structure of the check valve and reducing the overall cost of the control valve.

In addition, other improved features and advantages of the present disclosure will be expounded in the following specific implementations, and part of these features and advantages will become obvious in the description or by implementing the present disclosure. The purposes and other advantages of the present disclosure may be implemented and fulfilled by means of structures which are specified in the description and accompanying drawings.

### BRIEF DESCRIPTION OF THE DRAWINGS

Additional details and features of the disclosure are described in reference to the following figures in which:

FIG. 1 is a stereogram of a central oil control valve according to the present disclosure.

FIG. 2 is a semi-sectional view of the central oil control valve in FIG. 1.

FIG. 3 is a schematic structural diagram of a valve sleeve in a structure according to Embodiment 1 of the present disclosure.

FIG. 4 is a sectional view of the structure in a first operating mode according to Embodiment 1 of the present disclosure.

FIG. 5 is a sectional view of the structure in a second operating mode according to Embodiment 1 of the present disclosure.

FIG. 6 is a schematic structural diagram of a valve sleeve in a structure according to Embodiment 2 of the present disclosure.

FIG. 7 is a sectional view of the structure in a first operating mode according to Embodiment 2 of the present disclosure.

FIG. 8 is a sectional view of the structure in the first operating mode, from another perspective, according to Embodiment 2 of the present disclosure.

FIG. 9 is a sectional view of the structure in a second operating mode according to Embodiment 2 of the present disclosure.

FIG. 10 is a sectional view of the structure in the second operating mode, from another perspective, according to Embodiment 2 of the present disclosure.

FIG. 11 is a schematic structural diagram of a valve sleeve in a structure according to Embodiment 3 of the present disclosure.

FIG. 12 is a schematic structural diagram of a valve spool in the structure according to Embodiment 3 of the present disclosure.

FIG. 13 is a sectional view of the structure in a first operating mode according to Embodiment 3 of the present disclosure.

FIG. 14 is a sectional view of the structure in the first operating mode, from another perspective, according to Embodiment 3 of the present disclosure.

FIG. 15 is a sectional view of the structure in a second operating mode according to Embodiment 3 of the present disclosure.

FIG. 16 is a sectional view of the structure in the second operating mode, from another perspective, according to Embodiment 3 of the present disclosure.

### DETAILED DESCRIPTION

First, those skilled in the art should understand that the following implementations are merely used for explaining the technical principle of the embodiments of the application and are not intended to limit the protection scope of the embodiments of the application. Those skilled in the art may make adjustments as needed to adapt to specific application occasions.

In the description of the embodiments of the application, it should be noted that unless otherwise expressly stated and defined, terms such as “link” and “connect” should be understood in a broad sense. For example, “connect” may refer to fixed connection, detachable connection or integrated connection; mechanical connection or electrical connection; direct connection or indirect connection by means of an intermediate medium. Those ordinarily skilled in the art may appreciate the specific meanings of these terms in the embodiments of the application as the case may be.

Here, it should be noted that to prevent the present disclosure from being obscured by unnecessary details, only structures and/or steps closely related to the scheme of the present disclosure are shown in the drawings, and other details in little relation with the present disclosure are omitted.

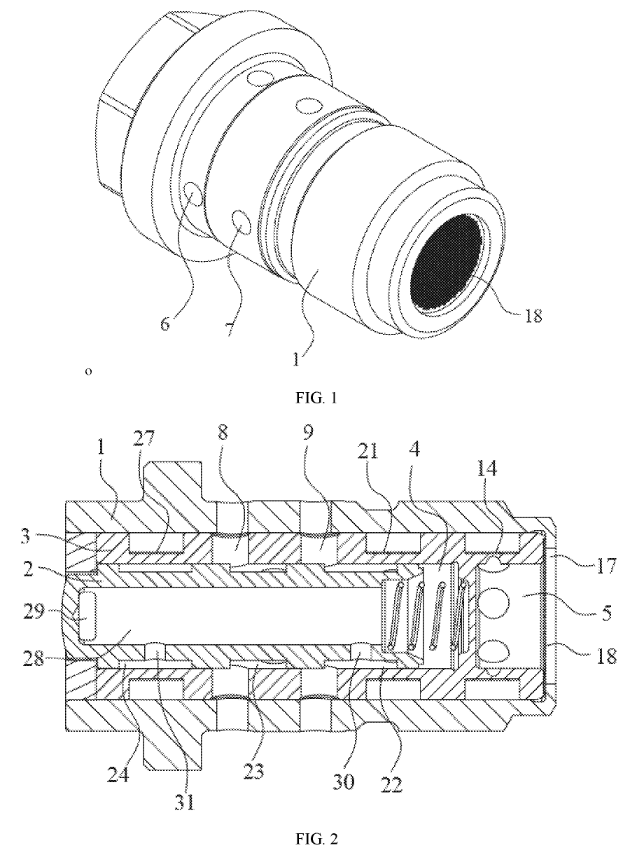

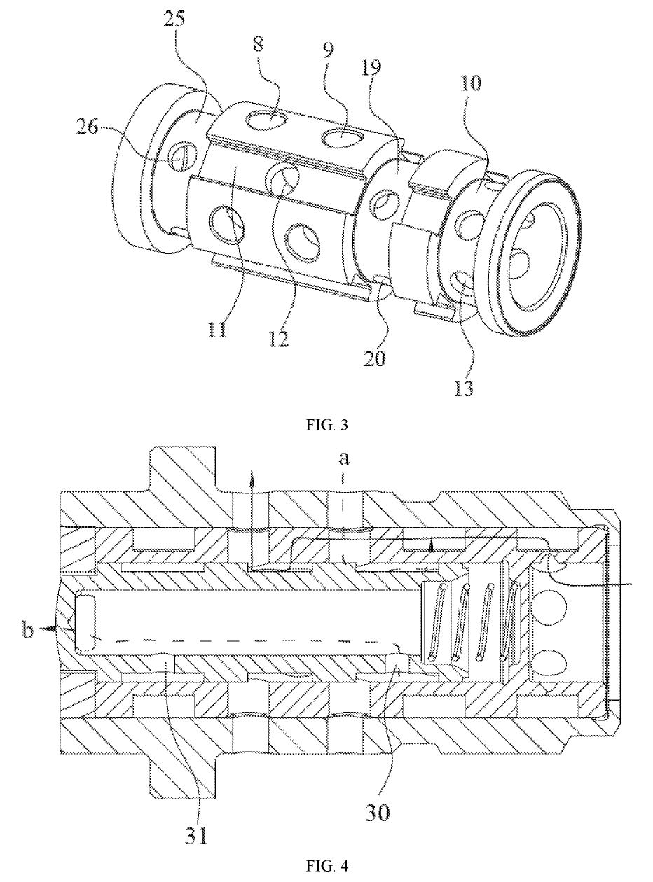

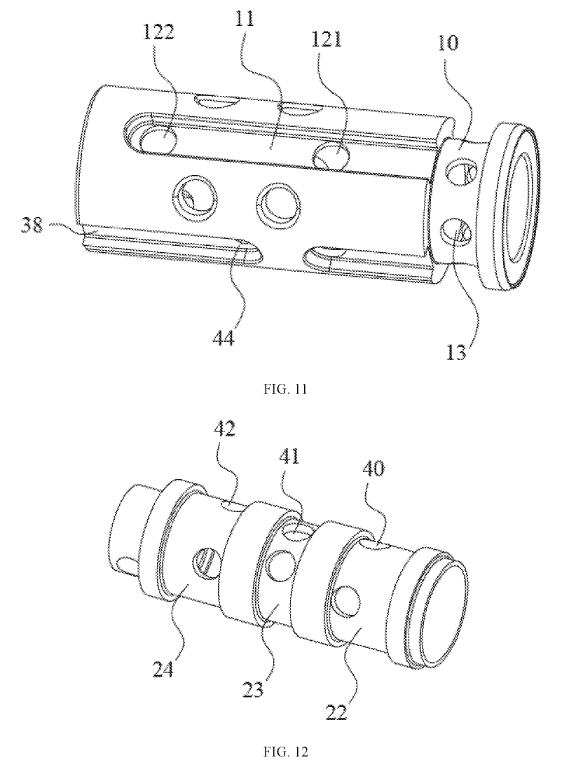

As shown in FIGS. 1-16, the present disclosure provides a central oil control valve, including a columnar valve body 1, a valve spool 2 and a valve sleeve 3, where the valve body 1 is disposed around the valve sleeve 3. Specifically, a receiving cavity 15 with an open end is formed in the valve body 1, one end of the valve sleeve 3 abuts against a bottom wall of the receiving cavity 15, a plug 16, abutting against the other end of the valve sleeve 3 in an axial direction, is arranged at the open end of the receiving cavity 15, an anti-rotation protrusion sticks out from an end, close to the valve sleeve 3, of the plug 16, and an anti-rotation groove is formed in the corresponding end of the valve sleeve 3. A valve chamber 4, extending in the axial direction, is formed in the end, close to the plug 16, of the valve sleeve 16, the valve spool 2 is slidably assembled in the valve chamber 4 in the axial direction, and a reset spring is arranged between the valve spool 2 and the bottom of the valve chamber 4. In an initial state, an end, away from the reset spring, of the valve spool 2 abuts against and limits the plug 16 under the action of the reset spring. In use, the valve spool 2 moves back and forth under the action of an oil pressure.

In the above structure, a central through-hole 17, communicating with an oil inlet chamber 5, is formed in the bottom of the receiving cavity 15, and a filter screen 18, used for covering the central through-hole 17, is clamped between the corresponding end of the valve sleeve 3 and the bottom wall of the receiving cavity 15. More specifically, a circular positioning groove is formed in the bottom of the valve sleeve 3, and in a thickness direction, one side of the filter screen 18 is received in the positioning groove, and the other side of the filter screen 18 abuts against the bottom of the receiving cavity 15, such that the filter screen 18 is clamped and limited between the valve sleeve 3 and the bottom wall of the receiving cavity 15 without other fasteners for connection, the structure is simple, and installation is convenient.

The oil inlet chamber 5 is formed in the end, away from the valve chamber 4, of the valve sleeve 3. A first working oil port 6 and a second working oil port 7, which respectively communicate with a phaser advance chamber and a phaser retard chamber, are formed in the valve body 1. A first oil hole 8 and a second oil hole 9, which respectively communicate with the first working oil port 6 and the second working oil port 7, are formed in the valve sleeve 3. A first circular groove 10 is formed in an outer wall of the end, close to the oil inlet chamber 5, of the valve sleeve 3. An oil passage 11, extending through the first circular groove 10 in the axial direction, is formed in an outer wall of the valve sleeve 3. An oil through-hole 12, communicating with the first oil hole 8 or the second oil hole 9, is formed in the bottom of the oil passage 11. A main oil inlet 13, communicating with the oil inlet chamber 5, is formed in the bottom of the first circular groove 10, and a first ring valve 14 capable of expanding to be opened unidirectionally under the action of a radial force is assembled in the first circular groove 10. In addition, a return check valve is arranged on the valve spool 2 or the valve sleeve 3.

When the valve spool 2 is located at a first position, the main oil inlet 13 unidirectionally communicates with the first oil hole 8 via the oil through-hole 12, and the second oil hole 9 unidirectionally communicates with the oil passage 11 via a second check valve; or, the main oil inlet 13 unidirectionally communicate with the second oil hole 9 via the oil through-hole 12, and the first oil hole 8 unidirectionally communicates with the oil passage 11 via the second check valve.

When the valve spool 2 is located at a second position, the main oil inlet 13 unidirectionally communicates with the second oil hole 9 via the oil through-hole 12, and the first oil hole 8 unidirectionally communicates with the oil passage 11 via the second check valve; or, the main oil inlet 13 unidirectionally communicates with the first oil hole 8 via the oil through-hole 12, and the second oil hole 9 unidirectionally communicates with the oil passage 11 via the second check valve.

Several structures and operating principles of the oil control valve are expounded in detail below with reference to specific embodiments.

### Embodiment 1

Referring to FIGS. 2-5, in this embodiment, a second circular groove 19 is formed in the outer wall of the valve sleeve 3 and located at a position close to the first circular groove 10, the second circular groove 19 communicates with the first circular groove 10 via the oil passage 11, a third oil hole 20 is formed in the bottom of the second circular groove 19, and a second ring valve 21 capable of expanding to be opened unidirectionally under the action of a radial force is assembled in the second circular groove 19 to form the return check valve. In addition, a third circular groove 22, a fourth circular groove 23 and a fifth circular groove 24, which are distributed at intervals in the axial direction, are formed in an outer wall of the valve spool 2.

In addition, in this embodiment, a sixth circular groove 25 is formed in an outer wall of the end, away from the oil inlet chamber 5, of the valve sleeve 3, and the sixth circular groove 25 communicates with the first circular groove 10 and the second circular groove 19 via the oil passage 11. A fourth oil hole 26 is formed in the bottom of the sixth circular groove 25, and a third ring valve 27 capable of expanding to be opened unidirectionally under the action of a radial force is assembled in the sixth circular groove 25.

An oil discharge chamber 28, extending in the axial direction, is formed in the valve spool 2, and an oil discharge passage 29, communicating with the oil discharge chamber 28, is formed in a side wall of an end, away from the oil inlet chamber 5, of the valve spool 2. A first oil discharge hole 30 and a second oil discharge hole 31, which communicate with the oil discharge chamber 28, are formed in the bottom of the third circular groove 22 and the bottom of the fifth circular groove 24 respectively.

When the structure in this embodiment is in a first operating mode (i.e., the first valve spool 2 is located at the first position), advance adjustment of the VVT phase is implemented:

Referring to FIG. 4, in the first operating mode, the valve spool 2 is located at the leftmost position, that is, high-pressure oil entering the oil inlet chamber 5 pushes open the first ring valve 14 to enter the oil passage 11, then sequentially passes through the oil through-hole 12, the fourth circular groove 23 and the first oil hole 8, and then enters the phaser advance chamber to drive a VVT rotor to implement advance adjustment of the VVT phase, where the oil inlet path is shown by the solid arrow. Under the action of the second check valve, oil will not enter a retard adjustment oil chamber from the oil passage 11 during advance adjustment of the VVT phase.

With the operation of a system, a large torque is applied to the VVT rotor to enable the VVT rotor to adjust the oil chamber in advance to generate a high oil pressure; when the high oil pressure is greater than the oil pressure of the oil inlet path, the first ring valve 14 is closed to effectively avoid oil return of the oil inlet path, such that the VVT adjustment speed is increased. Further, when the oil pushes the VVT rotor to implement advance adjustment of the VVT phase, the VVT retard adjustment oil chamber is in an oil draining state, where the oil draining path is shown by the dotted arrow a. Specifically, oil from the retard chamber enters the third circular groove via the second oil hole 9, and at this moment, the VVT retard adjustment oil chamber generates a high oil pressure under the action of a torque of a negative camshaft; when the oil pressure is greater than the oil pressure in the oil passage 11, the second ring valve 21 expands to be opened, and the oil enters the second circular groove 19 to be converged with oil in the oil passage 11, such that internal circulation of oil is realized, and an oil saving effect is achieved.

In this structure, one part of oil from the retard chamber internally circulates into the oil passage 11, and the other part of the oil from the retard chamber enters the oil discharge chamber 28 via the first oil discharge hole 30 and is finally discharged from the oil discharge passage 29 into an engine oil pan. The oil discharge path is shown by the dotted arrow b.

In a second operating mode (i.e., the valve spool 2 is located at the second position), retard adjustment of the VVT phase is implemented:

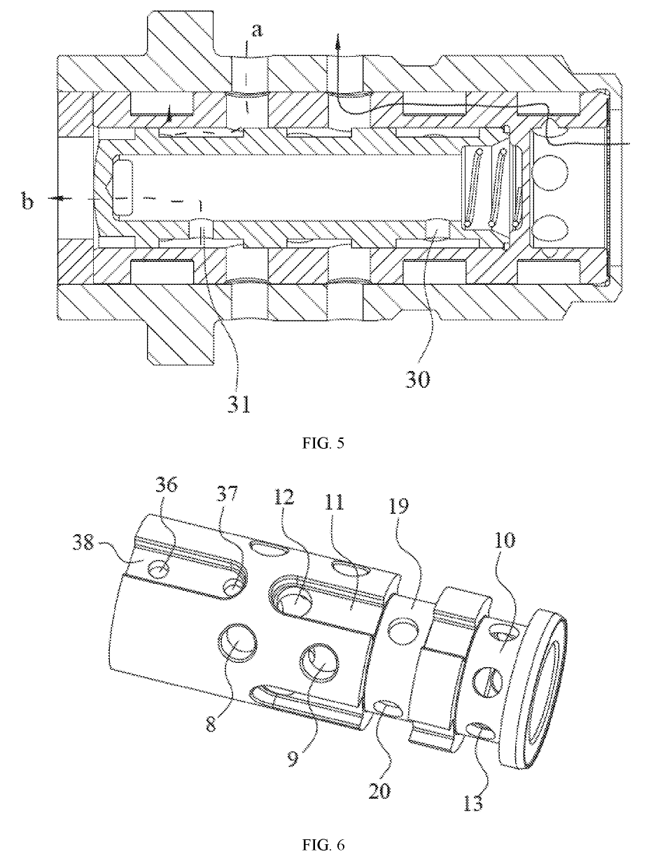

Referring to FIG. 5, in the second operating mode, the valve spool 2 is located at the rightmost position, high-pressure oil entering the oil inlet chamber pushes open the first ring valve 14 to enter the oil passage 11 and then sequentially passes through the oil through-hole 12, the fourth circular groove 23 and the second oil hole 9 to enter the phaser retard chamber. Similarly, due to the presence of the third ring valve 27, oil will not enter the advance chamber from the fifth circular groove 24. The oil inlet path is shown by the solid arrow.

With the operation of the system, the oil pressure in the retard chamber rises; when the oil pressure in the retard chamber is greater than the inlet oil pressure, the first ring valve 14 is closed. Similarly, when the oil pushes the VVT rotor to implement retard adjustment of the VVT phase, a VVT advance chamber is in an oil draining state. Specifically, oil from the advance chamber enters the fifth circular groove 24 via the first oil hole 8, at this moment, a high oil pressure is generated in the advance chamber under the action of a torque of a forward camshaft, the third ring valve 27 expands to be opened under the action of a radial oil pressure, and the oil enters the sixth circular groove 25 via the fourth oil hole 26 and is finally converged with oil in the oil passage 11, such that internal circulation of oil is realized. The oil draining path is shown by the dotted arrow a.

Similarly, in the second operating mode, part of oil from the advance chamber circulates internally, and the other part of the oil from the advance chamber enters the oil discharge chamber 28 via the second oil discharge hole 31 and is finally discharged from the oil discharge passage 29 into the engine oil pan. The oil discharge path is shown by the dotted arrow b.

### Embodiment 2

Referring to FIGS. 6-10, this embodiment is basically identical with Embodiment 1 in structure and is different from Embodiment 1 merely in the oil return structure for internal circulation. In this embodiment, the third ring valve 27 is omitted, and the same function as Embodiment 1 is achieved merely by means of the first ring valve 14 and the second ring valve 21.

Specifically, in this embodiment, a mounting cavity, extending in the axial direction, is formed in the valve spool 2, a core tube 32 is assembled in the mounting cavity, and a gap is formed between an outer circumferential wall of the core tube 32 and an inner circumferential wall of the mounting cavity to form a return oil passage 33. Specifically, in this structure, an internal groove, extending in the axial direction, is formed in the outer circumferential wall of the core tube 32, such that when the core tube 32 is assembled in the mounting cavity, the internal groove forms the return oil passage 33.

In addition, a fifth oil hole 34 and a sixth oil hole 35, which communicate with the return oil passage 33, are formed in the bottom of the third circular groove 22 and the bottom of the fifth circular groove 24 respectively. In addition, a third oil discharge hole 36 and a fourth oil discharge hole 37 are formed in a side wall of the end, away from the oil inlet chamber 5, of the valve sleeve 3. An oil discharge groove 38, vertically extending through the third oil discharge hole 36 and the fourth oil discharge hole 37, are formed in the outer wall of the valve sleeve 3, and an oil discharge passage 29, communicating with the oil discharge groove 38, is formed in the plug 16.

When the structure in this embodiment is in a first operating mode (i.e., the valve spool 2 is located at the first position), advance adjustment of the VVT phase is implemented:

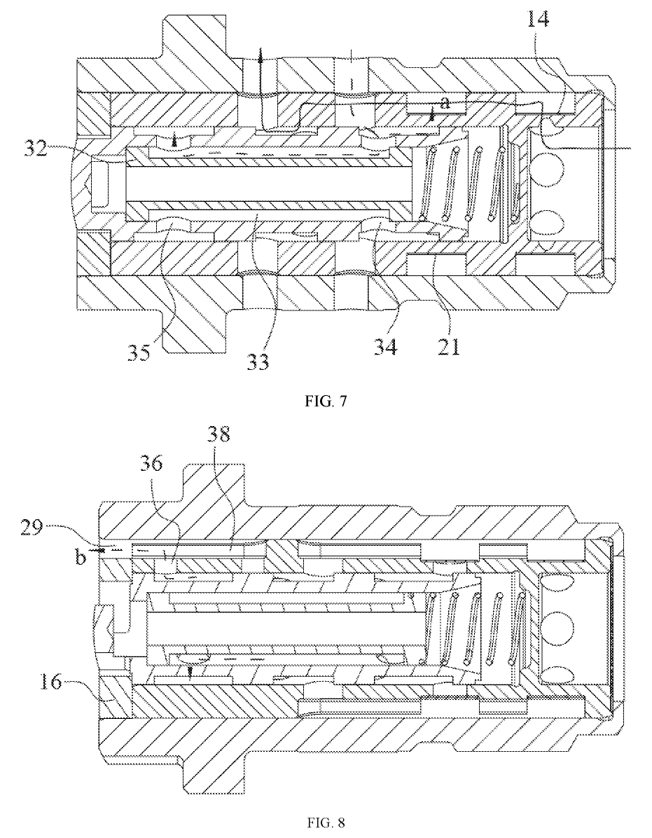

Referring to FIGS. 7 and 8, in the first operating mode, the valve spool 2 is located at the leftmost position, that is, high-pressure oil entering the oil inlet chamber 5 pushes open the first ring valve 14 to enter the oil passage 11, then sequentially passes through the oil passage 12, the fourth circular groove 23 and the first oil hole 8, and then enters the phaser advance chamber to drive the VVT rotor to implement advance adjustment of the VVT phase. Under the action of the second ring valve 21, oil will not enter the retard adjustment oil chamber from the oil passage 11 during advance adjustment of the VVT phase. The oil inlet path is shown by the solid arrow.

With the operation of a system, a large torque is applied to the VVT rotor to enable the VVT rotor to adjust the oil chamber in advance to generate a high oil pressure; when the high oil pressure is greater than the oil pressure of the oil inlet path, the first ring valve 14 is closed to effectively avoid oil return of the oil inlet path, such that the VVT adjustment speed is increased. Further, when the oil pushes the VVT rotor to implement advance adjustment of the VVT phase, the VVT retard adjustment oil chamber is in an oil draining state, where the oil draining path is as follows: oil from the retard chamber enters the third circular groove 22 via the second oil hole 9, and at this moment, the VVT retard adjustment oil chamber generates a high oil pressure under the action of a torque of a negative camshaft; when the oil pressure is greater than the oil pressure in the oil passage 11, the second ring valve 21 expands to be opened, and the oil enters the second circular groove 19 to be converged with oil in the oil passage 11, such that internal circulation of oil is realized, and an oil saving effect is achieved. The oil draining path is shown by the dashed line a.

In this structure, one part of oil from the retard chamber internally circulates into the oil passage 11, and the other part of the oil enters the return oil passage 33 from the third circular groove 22 via the fifth oil hole 34, then is discharged into the fifth circular groove 24 via the sixth oil hole 35, then enters the oil discharge groove 38 via the third oil discharge hole 36, and finally is discharged into an engine oil pan via the oil discharge passage 29. The oil draining path is shown by the dashed line b.

In a second operating mode (i.e., the valve spool 2 is located at the second position), retard adjustment of the VVT phase is implemented:

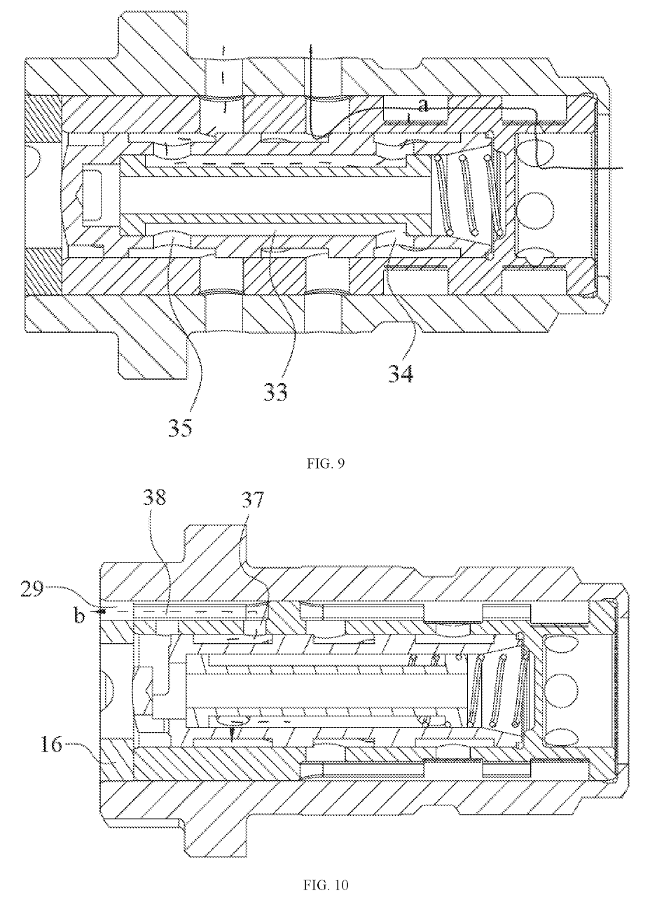

Referring to FIGS. 9 and 10, in the second operating mode, the valve spool 2 is located at the rightmost position, high-pressure oil entering the oil inlet chamber pushes open the first ring valve 14 to enter the oil passage 11, and then sequentially passes through the oil through-hole 12, the fourth circular groove 23 and the second oil hole 9 to enter the phaser retard chamber. Similarly, due to the presence of the second ring valve 21, oil will not enter the third ring valve 27 and thus will not enter the advance chamber via the return oil passage 33 and the fifth circular groove 24. The oil inlet path is shown by the solid arrow.

With the operation of the system, the oil pressure in the retard chamber rises; when the oil pressure in the retard chamber is greater than the inlet oil pressure, the first ring valve 14 is closed. Similarly, when the oil pushes the VVT rotor to implement retard adjustment of the VVT phase, a VVT advance chamber is in an oil draining state. Specifically, oil from the advance chamber enters the fifth circular groove 24 via the first oil hole 8 and then sequentially passes through the fifth oil hole 35, the return oil passage 33 and the fifth oil hole 34 to enter the third circular groove 22, at this moment, a high oil pressure is generated in the advance chamber under the action of a torque of a forward camshaft, the second ring valve 21 expands to be opened under the action of a radial oil pressure, and the oil enters the second circular groove 19 via the third oil hole 20 and is finally converged with oil in the oil passage 11, such that internal circulation of oil is realized. The oil draining path is shown by the dashed line a.

Similarly, in the second operating mode, one part of oil from the advance chamber circulates internally, and the other part of the oil from the advance chamber enters the oil discharge chamber 28 via the fourth oil discharge hole 37 and is finally discharged from the oil discharge passage 29 into the engine oil pan. The oil discharge path is shown by the dashed line b.

### Embodiment 3

Referring to FIGS. 11-16, this embodiment is basically identical with Embodiment 1 in structure and is obviously different from Embodiment 1 in the structure of the return check valve.

Specifically, in this embodiment, a third circular groove 22, a fourth circular groove 23 and a fifth circular groove 24, which are distributed at intervals in the axial direction, are formed in the outer wall of the valve spool 2. In addition, a support 39 is assembled in a cavity of the valve spool 2, a return oil passage 33 is formed between the support body 39 and an inner wall of the valve spool 2, and a seventh oil hole 40, an eighth oil hole 41 and a ninth oil hole 42, which communicate with the return oil passage 33, are formed in the bottom of the third circular groove 22, the bottom of the fourth circular groove 23 and the bottom of the fifth circular groove 24 respectively. An elastic membrane 43, used for fitting and sealing the eighth oil hole 41, is connected to the support 39 to form the return check valve. Here, the return check valve is a reed-type check valve.

Similarly, in this structure, a fifth oil discharge hole 44 is formed in a side wall of the valve sleeve 3, an oil discharge groove, vertically extending through the fifth oil discharge hole 44, is formed in the outer wall of the valve sleeve 3, and an oil discharge passage 29, communicating with the oil discharge groove 38, is formed in the plug 16.

The positions of the valve spool 2 in two operating modes in this embodiment are opposite to the positions of the valve spool 2 in the two operating modes in Embodiment 1, and the operating principle in this embodiment is the same as the operating principle in Embodiment 1.

When the structure in this embodiment is in a first operating mode (i.e., the valve spool is located at the second position), advance adjustment of the VVT phase is implemented:

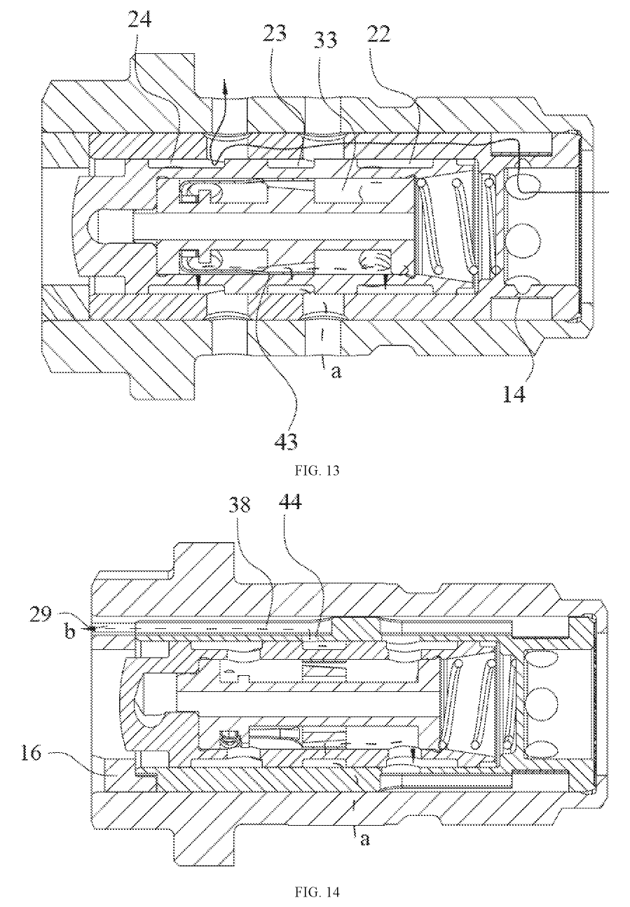

Referring to FIGS. 13 and 14, in the first operating mode, the valve spool 2 is located at the rightmost position, that is, high-pressure oil entering the oil inlet chamber 5 pushes open the first ring valve 14 to enter the oil passage 11, then sequentially passes through the oil through-hole 12, the fifth circular groove 24 and the first oil hole 8, and then enters the phaser advance chamber to drive a VVT rotor to implement advance adjustment of the VVT phase. Under the action of the second check valve, oil will not enter a retard adjustment oil chamber from the oil passage 11 during advance adjustment of the VVT phase. The oil inlet path is shown by the solid arrow.

With the operation of a system, a large torque is applied to the VVT rotor to enable the VVT rotor to adjust the oil chamber in advance to generate a high oil pressure; when the high oil pressure is greater than the oil pressure of the oil inlet path, the first ring valve 14 is closed to effectively avoid oil return of the oil inlet path, such that the VVT adjustment speed is increased. Further, when the oil pushes the VVT rotor to implement advance adjustment of the VVT phase, a VVT retard adjustment oil chamber is in an oil draining state, where the oil draining path is as follows: oil from the retard chamber enters the fourth circular groove via the second oil hole 9, and at this moment, the VVT retard adjustment oil chamber generates a high oil pressure under the action of a torque of a negative camshaft; when the oil pressure is greater than the oil pressure in the oil passage 11, the elastic membrane 43 deforms inwards to be opened in a radial direction, and the oil enters the return oil passage 33 and then sequentially passes through the seventh oil hole 40, the third circular groove 22 and the oil through-hole 12 to be converged with oil in the oil passage 11, such that internal circulation of oil is realized, and an oil saving effect is achieved. The oil draining path is shown by the dashed line a.

In this structure, one part of oil from the retard chamber internally circulates into the oil passage 11, and the other part of the oil enters the oil discharge groove 38 from the fourth circular groove 23 via the fifth oil discharge hole and is finally discharged from the oil discharge passage 29 into an engine oil pan. The oil draining path is shown by the dashed line b.

In a second operating mode (i.e., the valve spool 2 is located at the first position), retard adjustment of the VVT phase is implemented:

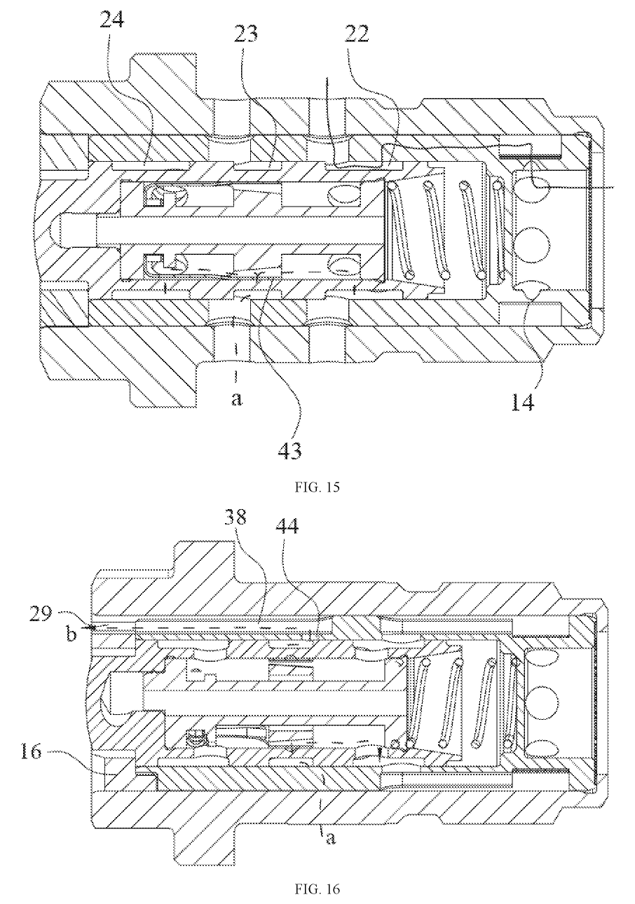

Referring to FIGS. 15 and 16, in the second operating mode, the valve spool 2 is located at the leftmost position, that is, high-pressure oil entering the oil inlet chamber pushes open the first ring valve 14 to enter the oil passage 11, and then sequentially passes through the oil through-hole 12, the third circular groove 22 and the second oil hole 9 to enter the phaser retard chamber. Similarly, due to the presence of the second check valve, oil will not enter the advance chamber. The oil inlet path is shown by the solid arrow.

When pressure in the retard chamber is greater than the inlet oil pressure, the first ring valve 14 is closed. Similarly, when the oil pushes the VVT rotor to perform retarding adjustment of the VVT phase, a VVT advance chamber is in an oil draining state. Specifically, oil from the advance chamber enters the fourth circular groove 23 via the first oil hole 8, at this moment, a high oil pressure is generated in the advance chamber under the action of a torque of a forward camshaft, the elastic membrane 43 deforms inwards to be opened in the radial direction, and the oil from the fourth circular groove 23 sequentially passes through the eighth oil hole 41 and the return oil passage 33, and then sequentially passes through the seventh oil hole 40, the third circular groove 22 and the oil through-hole 12 to be converged with oil in the oil passage 11, such that internal circulation of oil is realized, and an oil saving effect is achieved. The oil draining path is shown by the dashed line a.

Similarly, in this structure, one part of oil from the advance chamber internally circulates into the oil passage 11, and the other part of the oil enters the oil discharge groove 38 from the fourth circular groove 23 via the fifth oil discharge hole 44 and is finally discharged from the oil discharge passage 29 into the engine oil pan. The oil discharge path is shown by the dashed line b.

In addition, to improve working efficiency and achieve quick response to an adjustment action, in this embodiment, two oil through-holes 12 are formed in the side wall of the valve sleeve 3, and positions of the two oil through-holes 12 respectively correspond to positions of the first working oil port 6 and the second working oil port 7.

Specifically, referring to FIG. 11, an oil passage 11, extending in the axial direction, is formed in the outer wall of the valve sleeve 3, a first oil through-hole 121 is formed in a side, close to the oil inlet chamber 5, of the bottom of the oil passage 11, and a second oil through-hole 122 is formed in an end, close to the plug 16, of the bottom of the oil passage 11.

In the first operating mode, one part of oil discharged from the retard chamber sequentially passes through the return oil passage 33, the ninth oil hole 42, the fifth circular groove 24 and the second oil through-hole 122 to be converged with oil in the oil passage 11; the other part of the oil discharged from the retard chamber sequentially passes through the return oil passage 33, the seventh oil hole 40, the third circular groove 22 and the first oil through-hole 121 to be converged with oil in the oil passage 11, such that internal circulation of oil is realized.

Similarly, in the second operating mode, one part of oil discharged from the advance chamber sequentially passes through the return oil chamber 33, the ninth oil hole 42, the fifth circular groove 24 and the second oil through-hole 122 to be converged with oil in the oil passage 11; the other part of the oil discharged from the advance chamber sequentially passes through the return oil passage 33, the seventh oil hole 40, the third circular groove 22 and the first oil through-hole 121 to be converged with oil in the oil passage 11, such that internal circulation of oil is achieved.

The specific implementations of the application are described above, and the protection scope of the application is not limited to the above description. All transformations or substitutions easily obtained by any skilled in the art within the technical scope disclosed by the application should fall within the protection scope of the application. Therefore, the protection scope of the application should be subject to the protection scope of the claims.

1. A central oil control valve, comprising:
a valve body, a valve spool and a valve sleeve, the valve body being disposed around the valve sleeve, the valve spool being movably assembled in a valve chamber in one end of the valve sleeve in an axial direction, and an oil inlet chamber being formed in the other end of the valve sleeve; a first working oil port and a second working oil port, respectively communicating with a phaser advance chamber and a phaser retard chamber, being formed in the valve body, and a first oil hole and a second oil hole, respectively communicating with the first working oil port and the second working oil port, being formed in the valve sleeve, wherein a first circular groove is formed in an outer wall of the end, close to the oil inlet chamber, of the valve sleeve; an oil passage, extending through the first circular groove in the axial direction, is formed in an outer wall of the valve sleeve; an oil through-hole, communicating with the first oil hole or the second oil hole, is formed in a bottom of the oil passage; a main oil inlet, communicating with the oil inlet chamber, is formed in a bottom of the first circular groove; a first ring valve capable of expanding to be opened unidirectionally under the unction of a radial force is assembled in the first circular groove; a return check valve is arranged on the valve spool or the valve sleeve;
when the valve spool is located at a first position, the main oil inlet unidirectionally communicates with the first oil hole via the oil through-hole, and the second oil hole unidirectionally communicates with the oil passage via a second check valve; or, the main oil inlet unidirectionally communicates with the second oil hole via the oil through-hole, and the first oil hole unidirectionally communicates with the oil passage via the second check valve; and
when the valve spool is located at a second position, the main oil inlet unidirectionally communicates with the second oil hole via the oil through-hole, and the first oil hole unidirectionally communicates with the oil passage via the second check valve; or, the main inlet unidirectionally communicates with the first oil hole via the oil through-hole, and the second oil hole unidirectionally communicates with the oil passage via the second check valve.

2. The central oil control valve according to claim 1, wherein a receiving cavity with an open end is formed in the valve body, one end of the valve sleeve abuts against a bottom wall of the receiving cavity, and a plug, abutting against the other end of the valve sleeve in the axial direction, is arranged at the open end of the receiving cavity; an anti-rotation protrusion sticks out from an end, close to the valve sleeve, of the plug, and an anti-rotation groove is formed in the corresponding end of the valve sleeve.

3. The central oil control valve according to claim 2, wherein a central through-hole, communicating with the oil inlet chamber, is formed in a bottom of the receiving cavity, and a filter screen, used for covering the central through-hole, is clamped between the corresponding end of the valve sleeve and a bottom wall of the receiving cavity.

4. The central oil control valve according to claim 2, wherein a second circular groove is formed in the outer wall of the valve sleeve, the second circular groove communicates with the first circular groove via the oil passage, a third oil hole is formed in a bottom of the second circular groove, and a second ring valve capable of expanding to be opened unidirectionally under the action of a radial force is assembled in the second circular groove to form the return check valve; a third circular groove, a fourth circular groove and a fifth circular groove, which are distributed at intervals in the axial direction, are formed in an outer wall of the valve spool;
when the valve spool is located at the first position, the oil through-hole communicates with the first oil hole via the fourth circular groove, and the second oil hole communicates with the oil passage sequentially via the third circular groove and the second ring valve;
when the valve spool is located at the second position, the oil through-hole communicates with the second oil hole via the fourth circular groove, and the first oil hole communicates with the oil passage via the fifth circular groove.

5. The central oil control valve according to claim 4, wherein a sixth circular groove is formed in an outer wall of the end, away from the oil inlet chamber, of the valve sleeve, and the sixth circular groove communicates with the first circular groove and the second circular groove via the oil passage; a fourth oil hole is formed in a bottom of the sixth circular groove, and a third ring valve capable of expanding to be opened unidirectionally under the action of a radial force is assembled in the sixth circular groove.

6. The central oil control valve according to claim 5, wherein an oil discharge chamber, extending in the axial direction, is formed in the valve spool, and an oil discharge passage, communicating with the oil discharge chamber, is formed in a side wall of an end, away from the oil inlet chamber, of the valve spool; a first oil discharge hole and a second oil discharge hole, communicating with the oil discharge chamber, are formed in a bottom of the third circular groove and a bottom of the fifth circular groove respectively.

7. The central oil control valve according to claim 4, wherein a mounting cavity, extending in the axial direction, is formed in the valve spool, a core tube is assembled in the mounting cavity, a gap is formed between an outer circumferential wall of the core tube and an inner circumferential wall of the mounting cavity to form a return oil passage, and a fifth oil hole and a sixth oil hole, which communicate with the return oil passage, are formed in a bottom of the third circular groove and a bottom of the fifth circular groove respectively.

8. The central oil control valve according to claim 7, wherein a third oil discharge hole and a fourth oil discharge hole are formed in a side wall of the end, away from the oil inlet chamber, of the valve sleeve; an oil discharge groove, vertically extending through the third oil discharge hole and the fourth oil discharge hole, is formed in the outer wall of the valve sleeve, and an oil discharge passage, communicating with the oil discharge groove, is formed in the plug.

9. The central oil control valve according to claim 2, wherein a third circular groove, a fourth circular groove and a fifth circular groove, which are distributed at intervals in the axial direction, are formed in the outer wall of the valve sleeve, a support is assembled in a cavity of the valve spool, a return oil passage is formed between the support and an inner wall of the valve spool, and a seventh oil hole, an eighth oil hole and a ninth oil hole, which communicate with the return oil passage, are formed in a bottom of the third circular groove, a bottom of the fourth circular groove and a bottom of the fifth circular groove respectively; an elastic membrane, for fitting and sealing the eighth oil hole, is connected to the support to form the return check valve;
when the valve spool is located at the first position, the oil through-hole communicates with the second oil hole via the third circular groove, and the first oil hole communicates with the oil passage sequentially via the fourth circular groove, the elastic membrane and the return oil passage;
when the valve spool is located at the second position, the oil through-hole communicates with the first oil hole sequentially via the third circular groove, the return oil passage and the fifth circular groove, and the second oil hole communicates with the oil passage via the fourth circular groove and the elastic membrane.

10. The central oil control valve according to claim 9, wherein a fifth oil discharge hole is formed in a side wall of the valve sleeve; an oil discharge groove, vertically extending through the fifth oil discharge hole, is formed in the outer wall of the valve sleeve; an oil discharge passage, communicating with the oil discharge groove, is formed in the plug.
